(19) United States
(12) Patent Application Publication
(10) Pub. No.: US 2015/0319173 A1
(43) Pub. Date: Nov. 5, 2015

(54) CO-VERIFICATION METHOD, TWO DIMENSIONAL CODE GENERATION METHOD, AND DEVICE AND SYSTEM THEREFOR

(71) Applicant: TENCENT TECHNOLOGY (SHENZHEN) COMPANY LIMITED, Shenzhen (CN)

(72) Inventors: Shuai Hu, Shenzhen (CN); Xiao He, Shenzhen (CN)

(21) Appl. No.: 14/795,228

(22) Filed: Jul. 9, 2015

Related U.S. Application Data
(63) Continuation of application No. PCT/CN2013/088630, filed on Dec. 5, 2013.

(30) Foreign Application Priority Data
Jan. 11, 2013 (CN) 201310011258.7

(51) Int. Cl. H04L 29/06

(52) U.S. Cl. CPC H04L 63/0869; H04L 63/10

(57) ABSTRACT

A co-verification method, a two-dimensional code generation method, and a device and system therefor are provided. The method includes: performing first-type verification and second-type verification with a verification server, the first-type verification including at least one of user information verification, dynamic verification code verification, network shield verification, and token verification, and the second-type verification including two-dimensional verification; and receiving feedback information from the verification server, the feedback information being information sent by the verification server when the first-type verification and the second-type verification are both successful. By introducing two-dimensional code verification into the existing co-verification method, the problem that a user may encounter great loss once others take advantages of a terminal to complete identity verification with a verification server if the terminal is implanted with Trojan virus or lost is solved, thereby achieving more secure verification.

### CROSS-REFERENCE TO RELATED APPLICATION

This application is a continuation application of PCT Patent Application No, PCT/CN2013/088630, filed on Dec. 5, 2013, which is based upon and claims the benefit of priority from Chinese Patent Application No, 201310011258.7, filed on Jan. 11, 2013, the entire contents of which are incorporated herein by reference.

### TECHNICAL FIELD

The present disclosure relates to the field of network technologies, and in particular, to a co-verification method, a two-dimensional generation method, and a device and system therefor.

### BACKGROUND

With development of network application, users implement such services as games, transactions, and data exchanges on terminals using network accounts. The term “terminal” herein may be any one of a desk-top computer, a laptop, a smart phone, a tablet computer, and an e-book reader.

During use of the network accounts, the users identities need to be verified. Meanwhile, in consideration of security, co-verification may be implemented using two verification methods. For example, if the terminal is a smart phone, a conventional co-verification method includes: sending user information by the terminal to a verification server, where the user information generally includes user name and password; upon receiving the user information, sending a dynamically generated 6-digit verification code by the verification server to the terminal over a short message; upon receiving the 6-digit verification code, feeding back the 6-digit verification code by the terminal to the verification server by using a completed webpage input box or a short message; and performing matching for the user information and the 6-digit verification code respectively by the verification servers, and if the matching is successful, the verification is successful. When the verification is successful, service operations such as viewing, using, payment, downloading, and sharing may be performed.

Since the conventional co-verification has great dependency on the terminal, if the terminal is implanted with Trojan virus or lost, the user may encounter great loss once others take advantages of a terminal to complete identity verification with a verification server.

### SUMMARY

Embodiments of the present disclosure provide a co-verification method, a two-dimensional code generation method, and a device and system therefor. The technical solutions are as follows:

According to a first aspect of the present disclosure, a co-verification method is provided. The method includes:

performing first-type verification and second-type verification with a verification server, the first-type verification including at least one of user information verification, dynamic verification code verification, network shield verification, and token verification, and the second-type verification including two-dimensional code verification; and

receiving feedback information from the verification server, the feedback information being information sent by the verification server when the first-type verification and the second-type verification are both successful,

According to a second aspect of the present disclosure, a co-verification method is provided. The method includes:

performing first-type verification and second-type verification with a terminal, the first-type verification including at least one of user information verification, dynamic verification code verification, network shield verification, and token verification, and the second-type verification including two-dimensional code verification; and

sending feedback information to the terminal when the first-type verification and the second-type verification are both successful.

According to a third aspect of the present disclosure, a two-dimensional code generation method is provided. The method includes:

generating a two-dimensional verification code by interacting with a verification server, content data in the two-dimensional verification code including user information, and none or at least one of generated properties, a unique identifier, and an anti-counterfeiting encryption string; and

sending a manner of receiving the two-dimensional verification code to the verification server, the manner including receiving the two-dimensional verification code at a specified receiving end and/or locally receiving the two-dimensional verification code in the form of a one-time pop-up window; where the specified receiving end is at least one of a specified email, a specified instant messaging account, and a specified mobile phone number;

where the user information is used to identify a user; the generated properties include at least one of usage count, usage duration, usage scenario range, and usage permission within the usage scenario range of the two-dimensional verification code; the unique identifier is used to identify the two-dimensional verification code among all two-dimensional verification codes; and the anti-counterfeiting encryption string is used to authenticate the two-dimensional verification code.

According to a fourth aspect of the present disclosure, a two-dimensional code generation method is provided. The method includes:

generating a two-dimensional verification code by interacting with a terminal, content data in the two-dimensional verification code including user information, and none or at least one of generated properties, a unique identifier, and an anti-counterfeiting encryption string; and

receiving a manner of receiving the two-dimensional verification code from the terminal, the manner including receiving the two-dimensional verification code at a specified receiving end and/or locally receiving the two-dimensional verification code in the form of a one-time pop-up window; where the specified receiving end is at least one of a specified email, a specified instant messaging account, and a specified mobile phone number;

sending the two-dimensional verification code to the specified receiving end and/or the terminal according to the manner;

where the user information is used to identify a user; the generated properties include at least one of usage count, usage duration, usage scenario range, and usage permission within the usage scenario range of the two-dimensional verification code; the unique identifier is used to identify the current two-dimensional verification code among all two-dimensional verification codes; and the anti-counterfeiting encryption string is used to authenticate the current two-dimensional verification code.

According to a fifth aspect of the present disclosure, a terminal is provided. The terminal includes:

a verification executing module, configured to perform first-type verification and second-type verification with a verification server, the first-type verification including at least one of user information verification, dynamic verification code verification, network shield verification, and token verification, and the second-type verification including two-dimensional code verification; and

a verification receiving module, configured to receive feedback information from the verification server, the feedback information being information sent by the verification server when the first-type verification and the second-type verification are both successful.

According to a sixth aspect of the present disclosure, a verification server is provided. The verification server includes:

a verification executing module, configured to perform first-type verification and second-type verification with a terminal, the first-type verification including at least one of user information verification, dynamic verification code verification, network shield verification, and token verification, and the second-type verification including two-dimensional code verifications; and

a verification sending module, configured to send feedback information to the terminal when the first-type verification and the second-type verification performed by the verification executing module are both successful.

According to a seventh aspect of the present disclosure, a terminal is provided. The terminal includes:

a two-dimensional code generating module, configured to generate a two-dimensional verification code by interacting with a verification server, content data in the two-dimensional verification code including user information, and none or at least one of generated properties, a unique identifier, and an anti-counterfeiting encryption string; and

a manner sending module, configured to send a manner of receiving the two-dimensional verification code to the verification server, the manner including receiving the two-dimensional verification code at a specified receiving end and/or locally receiving the two-dimensional verification code in the form of a one-time pop-up window; where the specified receiving end is at least one of a specified email, a specified instant messaging account, and a specified mobile phone number;

where the user information is used to identify a user; the generated properties include at least one of usage count, usage duration, usage scenario range, and usage permission within the usage scenario range of the two-dimensional verification code; the unique identifier is used to identify the two-dimensional verification code among all two-dimensional verification codes; and the anti-counterfeiting encryption string is used to authenticate the two-dimensional verification code.

According to an eighth aspect of the present disclosure, a verification server is provided. The verification server includes:

a two-dimensional code generating module, configured to generate a two-dimensional verification code by interacting with a terminal, content data in the two-dimensional verification code including user information, and none or at least one of generated properties, a unique identifier, and an anti-counterfeiting encryption string;

a manner sending module, configured to receive a manner of receiving the two-dimensional verification code from the terminal, the manner including receiving the two-dimensional verification code at a specified receiving end and/or locally receiving the two-dimensional verification code in the form of a one-time pop-up window; where the specified receiving end is at least one of a specified email, a specified instant messaging account, and a specified mobile phone number; and

a two-dimensional code sending module, configured to send the two-dimensional verification code to the specified receiving end and/or the terminal according to the manner;

where the user information is used to identify a user; the generated properties include at least one of usage count, usage duration, usage scenario range, and usage permission within the usage scenario range of the two-dimensional verification code; the unique identifier is used to identify the two-dimensional verification code among all two-dimensional verification codes; and the anti-counterfeiting encryption string is used to authenticate the two-dimensional verification code.

According to a ninth aspect of the present disclosure, a co-verification system is provided. The system includes a terminal described according to the fifth aspect of the present disclosure, and a verification server according to the sixth aspect of the present disclosure.

According to a tenth aspect of the present disclosure, a two-dimensional code generation system is provided, including a terminal described according to the seventh aspect of the present disclosure, and a verification server according to the eighth aspect of the present disclosure.

The technical solutions provided in the embodiments of the present disclosure achieve the following beneficial effects:

By introducing two-dimensional code verification into the conventional co-verification method, the problem in the conventional co-verification method that a user may encounter great loss once others take advantages of a terminal to complete identity verification with a verification server if the terminal is implanted with Trojan virus or lost is solved. In this way, the entire verification depends partially on the terminal and partially on the two-dimensional verification code, and even though the terminal is implanted with Trojan virus or lost, the verification may not be successfully performed without the two-dimensional verification code, thereby achieving more secure verification.

### BRIEF DESCRIPTION OF THE DRAWINGS

For a better understanding of the technical solutions in the embodiments of the present disclosure, the accompanying drawings for illustrating the embodiments are briefly described below. Apparently, the accompanying drawings in the following description illustrate only some embodiments of the present disclosure, and persons of ordinary skill in the art may derive other accompanying drawings based on these accompanying drawings without any creative efforts.

FIG. 1 is a flowchart of a two-dimensional code generation method according to an embodiment of the present disclosure;

FIG. 2 is a flowchart of a two-dimensional code generation method according to another embodiment of the present disclosure of the present disclosure;

FIG. 3 is a flowchart of a co-verification method according to still another embodiment of the present disclosure;

FIG. 4 is a flowchart of a co-verification method according to yet still another embodiment of the present disclosure;

FIG. 5 is a structural block diagram of a two-dimensional code generation system accord mg to an embodiment of the present disclosure;

FIG. 6 is a structural block diagram of a two-dimensional code generation system according to another embodiment of the present disclosure;

FIG. 7 is a structural block diagram of a co-verification system according to an embodiment of the present disclosure;

FIG. 8 is a structural block diagram of a co-verification system according to another embodiment of the present disclosure;

FIG. 9 is a structural block diagram of a terminal according to an embodiment of the present disclosure; and

FIG. 10 is a structural block diagram of a verification server according to an embodiment of the present disclosure.

### DETAILED DESCRIPTION

To make the objectives, technical solutions, and advantages of the present disclosure clearer, the embodiments of the present disclosure are described in detail below with reference to the accompanying drawings.

For ease of description, a first-type verification includes but not limited to the following verification modes:

User information verification: A user sends user information over a terminal to a verification sewer, where the user information generally includes user name and password, the verification server matches the user information received from the terminal with pre-stored user information; and if the matching is successful, the verification is successful.

Dynamic verification code verification: During identity verification of the user, the verification server sends a dynamic verification code to the terminal of pre-bound to the user, and provides a dynamic verification code input interface; upon receiving the dynamic verification code on the pre-bound terminal, the user inputs the dynamic verification code into the interface; upon receiving the dynamic verification code, the verification server matches the dynamic verification code with the dynamic verification code sent to the terminal pre-bound to the user; and if the matching is successful, the verification is successful.

Network shield verification: The user pre-binds a network shield device to user information on the verification server; during identity verification, the user needs to insert the network shield device into the terminal; the verification server verifies whether the network shield information is network shield information bound to the user; if the network shield information is verified successfully, the verification is successful.

Token verification: The user pre-hinds a token to user information on the verification server; during identity verification, the user requests the user to input a 6-digit token verification code randomly generated by the token, and provides a token verification code input interface; the user inputs the 6-bit token verification code into the interface; after the verification server receives the 6-bit token verification code, the verification is successful.

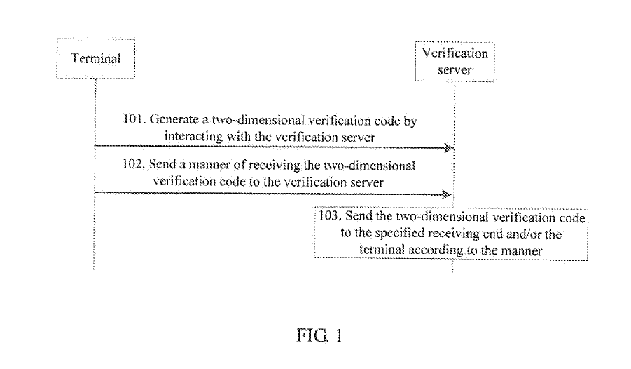

Referring to FIG. 1, a flowchart of a two-dimensional code generation method according to an embodiment of the present disclosure is illustrated. The two-dimensional code generation method includes:

Step 101: Generating a two-dimensional verification code by interacting with a verification server.

A terminal generates the two-dimensional verification code with the verification server, content data in the two-dimensional verification code includes user information, and zero to three item selected from generated properties, a unique identifier, and an anti-counterfeiting encryption string. The user information is used to uniquely identify a user; the generated properties include at least one of usage count, usage duration, usage scenario range, and usage permission within the usage scenario range of the two-dimensional verification code; the unique identifier is used to identify the current two-dimensional verification code among all two-dimensional verification codes; and the anti-counterfeiting encryption string is used to authenticate the current two-dimensional verification code.

Step 102: Sending a manner of receiving the two-dimensional verification code to the verification server.

The terminal sends the manner of receiving the two-dimensional verification code to the verification server, where the manner includes receiving the two-dimensional verification code at a specified receiving end and/or locally receiving the two-dimensional verification code in the form of a one-time pop-up window; where the specified receiving end is at least one of a specified email, a specified instant messaging account, and a specified mobile phone number;

Correspondingly, the verification server receives from the terminal the manner of receiving the two-dimensional verification code.

Step 103: Sending the two-dimensional verification code to the specified receiving end and/or the terminal according to the manner.

The verification server sends the two-dimensional verification code to the specified receiving end and/or the terminal according to the received manner.

In conclusion, according to the two-dimensional code generation method provided in this embodiment, a terminal sends a manner of receiving a two-dimensional verification code to a verification server, the verification server sends the two-dimensional verification code to a specified receiving end and/or sends the two-dimensional verification code in the form of a one-time pop-up window to the terminal according to the manner received front the terminal, in this way, an effect of preventing the two-dimensional verification code from being randomly acquired is achieved.

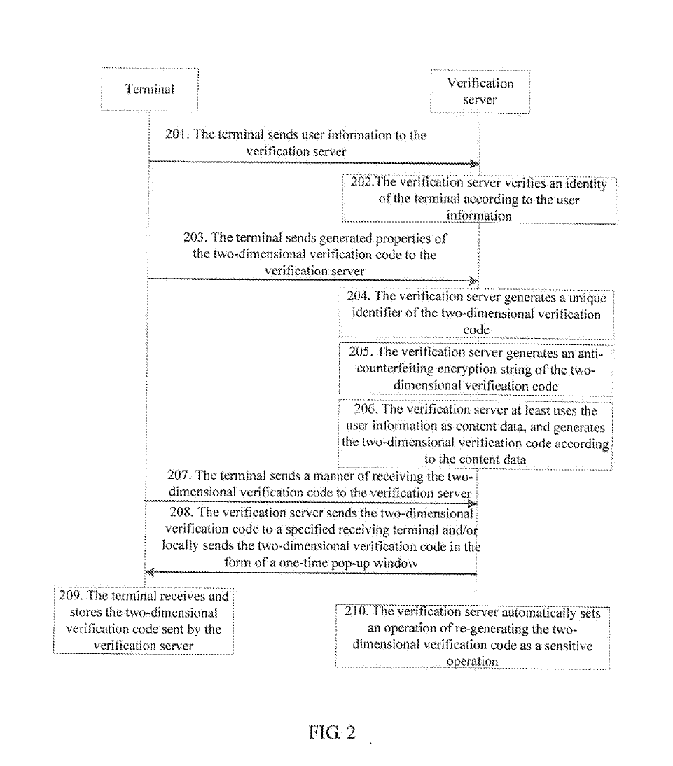

Referring to FIG. 2, a flowchart, of a two-dimensional code generation method according to another embodiment of the present disclosure is illustrated. Content data in a two-dimensional verification code may include user information, and none or at least one of generated properties, a unique identifier, and an anti-counterfeiting encryption string, in this embodiment, a two-dimensional verification code including the user information, the generated properties, the unique identifier, and the anti-counterfeiting encryption string is used as an example for description. The two-dimensional code generation method includes:

Step 201: A terminal sends user information to a verification server.

When the user plays games, conducts transactions, and implements data exchange using the network accounts in the terminal, the identity of the user needs to be verified. The terminal herein may be a computer, a mobile phone, or a smart electronic device. During identity verification, the user needs to send the user information to the verification server. For example, when the user uses virtual accounts on the terminal, the user needs to input user name and password on a login interface.

Correspondingly, the verification server receives the user information from the terminal.

Step 202: The verification server verifies an identity of the terminal according to the user information.

Upon receiving the user information from the user, the verification server matches the received user information with pre-stored user information; and if the matching is successful, the verification is successful.

Upon successfully verifying the identity of the user, the verification server may send a verification result to the terminal, and send a request for querying whether the two-dimensional verification code needs to be generated to the terminal. If the terminal needs to generate the two-dimensional verification code, the verification server may provide the terminal with a window or webpage for setting generated properties of the two-dimensional verification code.

Step 203: The terminal sends generated properties of the two-dimensional verification code to the verification server.

The user sends the generated properties of the two-dimensional verification code to be generated to the verification server. The generated properties of the two-dimensional verification code include at least one of usage count, usage duration, usage scenario range, and usage permission within the usage scenario range. For example, the user may set the usage count of the two-dimensional verification code to 3, and the usage duration refers to a usage time range of the two-dimensional verification code. For example, the user may set the usage duration of the two-dimensional verification code to 3 months, and the usage duration range is 3 months starting from the data of generation of the two-dimensional verification code; and the usage scenario refers to a website range where the two-dimensional verification code can be used. For example, the usage scenario of the two-dimensional verification code of the user using the virtual accounts is a virtual account on a X website; the usage permission within the usage scenario refers to a usage permission of the two-dimensional verification code within the usage scenario range. For example, the usage permission of the two-dimensional verification code of the user using the virtual accounts may include login, viewing, payment, transaction, and the like.

Step 204: The verification server generates a unique identifier of the two-dimensional verification code.

The verification server generates the unique identifier for the two-dimensional verification code, where the unique identifier is used to identify the current two-dimensional verification code among all two-dimensional verification codes. For example, the unique identifier may be a digital identifier 123.

Step 205: The verification server generates an anti-counterfeiting encryption string of the two-dimensional verification code.

The verification server generates the anti-counterfeiting encryption string for the two-dimensional verification code, where the anti-counterfeiting encryption string is used to authenticate the current two-dimensional verification code. For example, the anti-counterfeiting encryption string may be a Message-Digest Algorithm 5 (MD5) value acquired using the MD5.

Step 206: The verification server at least uses the user information as content data, and generates the two-dimensional verification code according to the content data.

Upon receiving the generated properties of the two-dimensional verification code from the terminal, the verification server at least uses the user information as the content data, and generates the two-dimensional verification code according to the content data. To be specific, the verification server firstly uses the user information as a part of the content data, uses the generated properties of the two-dimensional verification code as a part of the content data, uses the unique identifier as a part of the content data, uses the anti-counterfeiting encryption string as a part of the content data, and finally generates the two-dimensional verification code according to the content data.

Although this embodiment is described by only using the case where the content data in the two-dimensional verification code includes the user information, the generated properties, the unique identifier, and the anti-counterfeiting encryption string as an example, other embodiments where the content data in the two-dimensional verification code includes the user information, and none or at least one of the generated properties, the unique identifier, and the anti-counterfeiting encryption string are readily envisaged by a person skilled in the art, which are thus not described herein any further.

During generation of the two-dimensional verification code according to the content data, the following sub-steps may be included: the verification server encrypts the content data, acquires the encrypted content data, and generates the two-dimensional verification code according to the encrypted content, data.

For example, upon using the user information, the generated properties set by the user for the two-dimensional verification code, the unique identifier, and the anti-counterfeiting encryption string as the content data, the verification server encrypts the content data, acquires the encrypted content data, and generates the two-dimensional verification code according to the encrypted content data.

Steps 201-206 complete the generation of the two-dimensional verification code. That is, the terminal successfully generates the two-dimensional verification code by interacting with the verification server.

Step 207: The terminal sends a manner of receiving the two-dimensional verification code to the verification server.

The owner of the two-dimensional verification code may not be the user of the current terminal. For example, two users own the same virtual account, where upon generating a two-dimensional verification code, user A expects user B to carry the two-dimensional verification code. In addition, to prevent the two-dimensional verification code from being maliciously acquired, the terminal may send a manner of receiving the two-dimensional verification code to the verification server, where the manner includes: receiving the two-dimensional verification code at a specified receiving end and/or locally receiving the two-dimensional verification code in the form of a one-time pop-up window; where the specified receiving end is at least one of a specified email, a specified instant messaging account, and a specified mobile phone number.

Correspondingly, the verification server receives from the terminal the manner of receiving the two-dimensional verification code.

Step 208: The verification server sends the two-dimensional verification code to a specified receiving end and/or sends the two-dimensional verification code in the form of a one-time pop-up window.

If the manner of receiving the two-dimensional verification code is receiving the two-dimensional verification code at the specified receiving end, the verification server sends the two-dimensional verification code to the specified receiving end. For example, if the specified receiving end is an email, the verification server sends the two-dimensional verification code to the email; if the specified receiving end is an instant messaging account, the verification server sends the two-dimensional verification code to the instant messaging account; and if the specified receiving end is a mobile phone number, the verification server sends the two-dimensional verification code to the mobile phone number over a multimedia message.

If the manner of receiving the two-dimensional verification code is locally receiving the two-dimensional verification code in the form of a one-time pop-up window, the verification server sends the two-dimensional verification code to the terminal in the form of a one-time pop-up window.

Step 209: The terminal receives and stores the two-dimensional verification code sent by the verification server.

If the verification server sends the two-dimensional verification server to the specified receiving end, the user opens the specified receiving end, and receives and stores the two-dimensional verification code. For example, if the specified receiving end is an email, the user using the email may open the email box on the terminal or other terminals, and receive and store the two-dimensional verification code; if the specified receiving end is an instant messaging account, the user using the instant messaging account may open the instant messaging account on the terminal or other terminals, and receive and store the two-dimensional verification code; if the specified receiving end is a specified mobile phone number, the user using the specified mobile phone number may receive the two-dimensional verification code over a multimedia message in a mobile phone, and store the two-dimensional verification code. The user may store the two-dimensional verification code in the form of: an electronic picture or a piece of paper with the two-dimensional verification code printed thereon. Preferably, it is recommended that the user store the two-dimensional verification code in the form a piece of paper with the two-dimensional verification code printed thereon. This prevents the case where the two-dimensional verification code leaks when the receiving end is eavesdropped, or the case where the two-dimensional verification code is missing when the receiving end is lost.

If the verification server sends the two-dimensional verification code to the terminal in the form of a one-time pop-up window, and the user receives, on the terminal, the pop-up window displaying the two-dimensional verification code, the user may store the two-dimensional verification code in the form of an electronic picture or a piece of paper with the two-dimensional verification code printed thereon. Preferably, it is recommended that the user store the two-dimensional verification code in the form a piece of paper with the two-dimensional verification code printed thereon. This prevents the case where the two-dimensional verification code leaks when the receiving end is eavesdropped, or the case where the two-dimensional verification code is missing when the receiving end is lost.

Step 210: The verification server automatically sets an operation of re-generating the two-dimensional verification code as a sensitive operation.

In another aspect, since the owner of the two-dimensional verification code may not be the user of the current terminal. For example, two users use the same virtual accounts, after the two-dimensional verification code is generated, to prevent an individual user from generating a two-dimensional verification code by himself or herself, upon sending the two-dimensional verification code to the specified receiving end and/or sending the two-dimensional verification code in the form of a one-time pop-up window, the verification server automatically sets an operation for re-generating the two-dimensional verification code as a sensitive operation, where the sensitive operation is an operation that is executable when first-type verification and second-type verification are both successful. For example, if receiving a request for re-generating the two-dimensional verification code from the current terminal or another terminal, the verification server detects whether the first-type verification and the second-type verification are both successful; if the detection result indicates that the first-type verification and the second-type verification are both successful, the two-dimensional verification code is re-generated.

In conclusion, according to the two-dimensional code generation method provided in this embodiment, a terminal sends a manner of receiving a two-dimensional verification code to a verification server, the verification server sends the two-dimensional verification code to a specified receiving end and/or sends the two-dimensional verification code in the form of a one-time pop-up window to the terminal according to the manner received from the terminal. In this way, an effect of preventing the two-dimensional verification code from being randomly acquired is achieved. In addition, after the verification server sends the two-dimensional verification code to the specified receiving end and/or sends the two-dimensional verification code in the form of a one-time pop-up window, an operation of re-generating the two-dimensional verification code is automatically set as a sensitive operation, thereby achieving an effect of preventing the two-dimensional verification, code from being randomly generated.

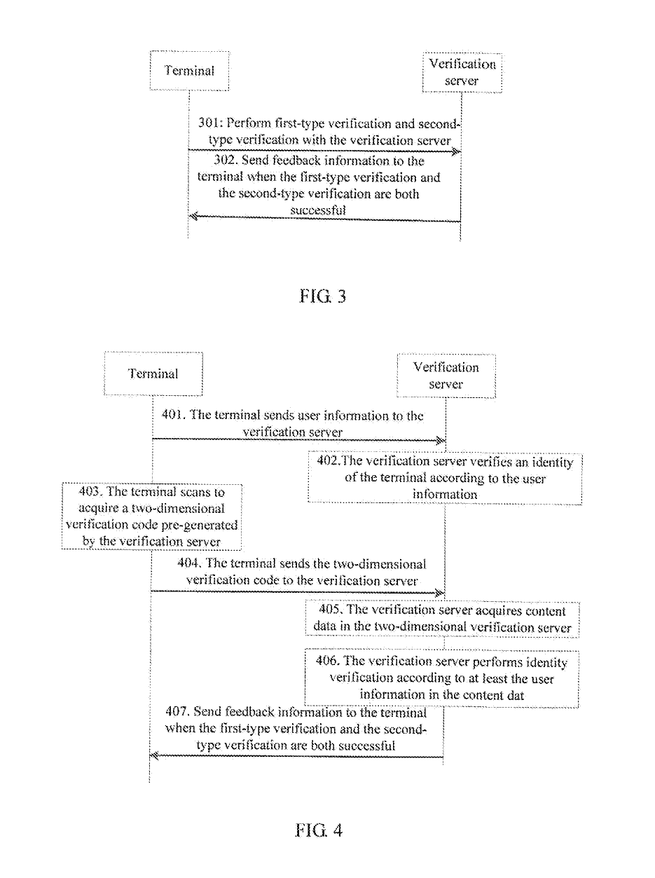

Referring to FIG. 3, a flowchart of a co-verification method according, to still another embodiment of the present disclosure is illustrated. The co-verification method includes:

Step 301: Performing first-type verification and second-type verification with a verification server.

A terminal performs first-type verification and second-type verification with a verification server, where the first-type verification includes but not limited, to at least one of user information verification, dynamic code verification, network shield verification, and token verification, and the second-type verification including two-dimensional verification.

Step 302: Sending feedback information to the terminal when the first-type verification and the second-type verification are both successful.

When the first-type verification and the second-type verification are both successful, the verification server sends feedback information to the terminal, where the feedback information is information sent by the verification server when the first-type verification and the second-type verification are both successful.

Correspondingly, the terminal receives the feedback information from the verification server.

In conclusion, by introducing two-dimensional code verification into the conventional co-verification method, the problem in the conventional co-verification method that a user may encounter great loss once others take advantages of a terminal to complete identity verification with a verification server if the terminal is implanted with Trojan virus or lost is solved. In this way, the entire verification depends partially on the terminal and partially on the two-dimensional verification code, and even though the terminal is implanted with Trojan virus or lost, the verification may not be successfully performed without the two-dimensional verification code, thereby achieving more secure verification.

It should be further noted that the two-dimensional code involved in the second-type verification in this embodiment is a two-dimensional verification code generated according to the verification code generation method provided in the embodiment illustrated in FIG. 1 or the embodiment illustrated in FIG. 2. To be specific, the generated two-dimensional verification code in the embodiment illustrated in FIG. 1 or the embodiment illustrated in FIG. 2 is used for the second-type verification during co-verification by the terminal and the verification server, where the verification is successful when the first-type verification and the second-type verification are both successful.

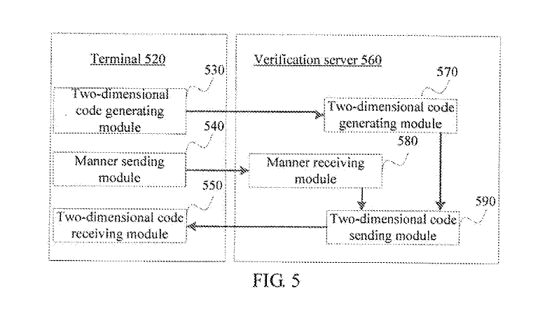

Referring to FIG. 4, a flowchart of a co-verification method according to yet still another embodiment of the present disclosure is illustrated. In this embodiment, a case where first-type verification includes only user information verification and content data in a two-dimensional verification code involved in second-type verification includes user information, generated properties, a unique identifier, and an anti-counterfeiting encryption string is used as an example for description. For details of embodiments involving other types of verification, reference may be made to the above description, which is readily envisaged by a person skilled in the art and is thus not described herein any further. The co-verification method includes:

Step 401: A terminal sends user information to a verification server.

For example, when the user logs in to the virtual account for payment, the user information is sent to the verification server over the terminal.

Step 402: The verification server verifies an identity of the terminal according to the user information.

The verification server matches the user information received from the terminal with pre-stored user information; and if the matching is successful, the verification is successful.

Steps 401-402 complete the first-type verification.

During identify verification of the user, in addition to verification of the user information, pre-generated two-dimensional verification code information needs to be verified, where the two-dimensional verification code may be owned by the current user or may be owned together by users using the virtual account. If the two-dimensional verification code is owned together by users using the virtual account, during identity verification of the user, consent needs to be acquired from the users using the virtual account, and the pre-generated two-dimensional verification code is acquired to perform the second-type verification, i.e., two-dimensional code verification.

Step 403: The terminal scans to acquire a two-dimensional verification code pre-generated by the verification server.

To be specific, if the pre-generated two-dimensional verification code is stored in the form of an electronic picture, the terminal may scan to acquire the two-dimensional verification code using an application program. For example, the user may read, using an application program of a smart phone, the stored electronic picture of the two-dimensional verification code. If the pre-generated two-dimensional verification code is stored in the form of a piece of paper with the two-dimensional, verification code printed thereon, the terminal may scan, using a camera, to acquire the two-dimensional verification code. For example, the user may scan, using the camera of the smart phone, to acquire the two-dimensional verification code on the paper.

Step 404: The terminal sends the two-dimensional verification code to the verification server.

Upon acquiring the two-dimensional verification code, the terminal sends the two-dimensional verification code to the verification server.

Step 405: The verification server acquires content data in the two-dimensional verification server.

Upon receiving the two-dimensional verification code from the user, the verification server acquires the content data in the two-dimensional verification code. The content data includes the user information, and the generated properties, the unique identifier, and the anti-counterfeiting encryption string of the two-dimensional verification code.

The user information includes user name and password, and may further includes a verification code, a mobile phone message verification code, and the like; the generated properties of the two-dimensional verification code include at least one of usage count, usage duration, usage scenario range, and usage permission within the usage scenario range; the unique identifier is to identify the current two-dimensional verification code among all two-dimensional verification codes; and the anti-counterfeiting encryption string is used to authenticate the current two-dimensional verification code.

Although this embodiment is described by only using the case where the content data in the two-dimensional verification code includes the user information, the generated properties, the unique identifier, and the anti-counterfeiting encryption string as an example, other embodiments where the content data in the two-dimensional verification code includes the user information, and none or at least one of the generated properties, the unique identifier, and the anti-counterfeiting encryption string are readily envisaged by a person skilled in the art, which are thus not described herein any further.

Step 406: The verification server performs identity verification according to at least the user information in the content data.

This step specifically includes the following six sub-steps:

Sub-step 1: The verification server searches, according to the unique identifier, for an anti-counterfeiting encryption string corresponding to the current two-dimensional verification code.

For example, the verification server searches, according to a unique identifier 123 in the acquired two-dimensional verification code, for an MD5 value of the anti-counterfeiting encryption string corresponding to the current two-dimensional verification code.

Sub-step 2: The verification server authenticates the current two-dimensional verification code according to the anti-counterfeiting encryption string.

The verification server authenticates the current two-dimensional verification code according to the anti-counterfeiting encryption string. For example, the verification server matches the MD5 value of the anti-counterfeiting encryption string of the current two-dimensional verification code with the MD5 value of a pre-stored anti-counterfeiting encryption string; and if the matching is successful, the authentication is successful.

Sub-step 3: If successfully authenticating the current two-dimensional verification code, the verification server searches, according to the unique identifier, for user information corresponding to the current two-dimensional verification code.

The verification server searches, according to the unique identifier, for example, a unique identifier 123, in the acquired two-dimensional verification code, the user information corresponding to the current two-dimensional verification code.

Sub-step 4: The verification server matches the acquired user information with pre-stored user information; and if the matching is successful, the verification is successful. For example, the verification server of the virtual account acquires the user information in the two-dimensional verification code, and matches the acquired user information with all pre-stored user information; and if the matching is successful, the verification is successful.

Sub-step 5: The verification server searches, according to the unique identifier, for generated properties corresponding to the current two-dimensional verification code.

The verification serer searches, according to the unique identifier in the acquired two-dimensional verification code, the generated properties corresponding to the current two-dimensional verification code. For example, the verification server searches, according to a unique identifier 123 in the acquired two-dimensional verification code, the generated properties corresponding to the current two-dimensional verification code.

Sub-step 6: Upon successfully matching the acquired user information with the pre-stored user information, the verification server needs to detect whether the generated properties in the two-dimensional verification code satisfy predetermined conditions.

Upon successfully matching the acquired user information with the pre-stored user information, the verification server detects whether the generated properties in the two-dimensional verification code satisfy the predetermined conditions. The predetermined conditions include at least one of the following:

A current usage count of the two-dimensional verification code is smaller than the usage count specified in the generated properties. For example, if the current usage count of the two-dimensional verification code is 2, and the usage count specified in the generated properties is 3, then the generated properties satisfy the predetermined conditions.

Current usage time of the two-dimensional verification code falls within the usage duration specified in the generated properties. For example, if the current usage time of the two-dimensional verification code is Nov. 31, 2012, and a validity expiration date calculated based on the usage duration is Dec. 21, 2012, then the current usage time is before the validity expiration date, and the generated properties satisfy the predetermined conditions.

A current usage scenario range of the two-dimensional verification code is within the usage scenario range specified in the generated properties. For example, if current usage scenario range of the two-dimensional verification code is a virtual account on the X website, and the usage scenario range specified in the generated properties is also the virtual account on the X website, then the generated properties satisfy the predetermined conditions.

A usage permission within the usage scenario range of the two-dimensional verification code is smaller than or equal to the usage permission within the usage scenario range specified in the generated properties. For example, if the usage permission within the usage scenario range of the two-dimensional verification code is payment, and the usage permission within the usage scenario range specified in the generated properties is also payment, then the generated properties satisfy the predetermined conditions.

If the generated properties of the two-dimensional verification code all satisfy the predetermined conditions, the verification is successful.

Steps 403-406 complete the second-type verification. The second-type verification herein is described using the two-dimensional verification code including the user information, the generated properties, the unique identifier, and the anti-counterfeiting encryption string. Other embodiments where the content data in the two-dimensional verification code includes the user information, and none or at least one of the generated properties, the unique identifier, and the anti-counterfeiting encryption string are readily envisaged by a person skilled in the art, which are thus not described herein any further.

Step 407: Sending feedback information to the terminal when the first-type verification and the second-type verification are both successful,

When the first-type verification and the second-type verification are both successful, the verification server sends the feedback information to the terminal. The feedback information is information sent when the first-type verification and the second-type verification are both successful. For example, the feedback information may be information indicating verification success, or information indicating that a sensitive operation is directly performed after the verification is successful.

Correspondingly, the terminal receives the feedback information from the verification server.

It should be further noted that either of the first-type verification or the second-type verification may take precedence over to the other, or the first-type verification and the second-type verification may be performed concurrently.

The first-type verification herein is described using a two-dimensional verification code including only user information as an example. In practice, the first-type verification may involve one or more of user information verification, dynamic verification code verification, network shield verification, and token verification. For example, in the case where three game users use the same game account to play network games, virtual properties of the game account include game equipment pertaining to the three users. In this case, the user may define that if the game equipment is to be sold or exchanged, such transaction may be implemented by co-verification by the three game users. In this case, two of the three game users may respectively use the dynamic verification code verification and the network shield verification in the first-type verification, and the third game user may use the two-dimensional code verification in the second-type verification, lithe game equipment is to be sold or exchanged, such transaction may be successfully carried out by successful co-verification including the dynamic verification code verification, the network shield verification, and the two-dimensional code verification.

In conclusion, by introducing two-dimensional code verification into the conventional co-verification method, the problem in the conventional co-verification method that a user may encounter great loss once others take advantages of a terminal to complete identity verification with a verification server if the terminal is implanted with Trojan virus or lost is solved. In this way, the entire verification depends partially on the terminal and partially on the two-dimensional verification code, and even though the terminal is implanted with Trojan virus or lost, the verification may not be successfully performed without the two-dimensional verification code, thereby achieving more secure verification. In this embodiment, during two-dimensional code verification, verification of user information in content data, generated properties, a unique identifier, and an anti-counterfeiting encryption string of the two-dimensional code enables more secure two-dimensional code verification, thereby achieving more secure verification.

It should be further noted that the two-dimensional code involved in the second-type verification in this embodiment is a two-dimensional verification code generated according to the verification code generation method provided in Embodiment 1 or Embodiment 2. To be specific, the generated two-dimensional verification code in the embodiment illustrated in FIG. 1 or the embodiment illustrated in FIG. 2 is used for the second-type verification during co-verification by the terminal and the verification server, where the verification is successful when the first-type verification and the second-type verification are both successful.

Embodiments of the present disclosure for apparatus are described hereinafter. For similar details which are not illustrated herein, reference may be made to the corresponding method embodiments.

Referring to FIG. 5, a structural block diagram of a two-dimensional code generation system according to an embodiment of the present disclosure is illustrated. The two-dimensional code generation system includes: a terminal 520 and a verification server 560.

The terminal 520 includes: a two-dimensional code generating module 530, a manner sending module 540, and a two-dimensional code receiving module 550.

The two-dimensional code generating module 530 is configured to generate a two-dimensional verification code by interacting with a verification server, content data in the two-dimensional verification code including user information, and none or at least one of generated properties, a unique identifier, and an anti-counterfeiting encryption string.

The manner sending module 540 is configured to send a manner of receiving the two-dimensional verification code to the verification server, the manner including receiving the two-dimensional verification code at a specified receiving end and/or locally receiving the two-dimensional verification code in the form of a one-time pop-up window; where the specified receiving end is at least one of a specified email, a specified instant messaging account, and a specified mobile phone number.

The user information is used to identify a user; the generated properties include at least one of usage count, usage duration, usage scenario range, and usage permission within the usage scenario range of the two-dimensional verification code; the unique identifier is used to identify the current two-dimensional verification code among all two-dimensional verification codes; and the anti-counterfeiting encryption string is used to authenticate the current two-dimensional verification code.

The two-dimensional code receiving module 550 is configured to receive the two-dimensional verification code from the verification server.

The verification server 560 includes: a two-dimensional code generating module 570, a manner receiving manner 580, and a two-dimensional code sending module 590.

The two-dimensional code generating module 570 is configured to generate a two-dimensional verification code by interacting with a terminal, content data in the two-dimensional verification code including user information, and none or at least one of generated properties, a unique identifier, and an anti-counterfeiting encryption string.

The manner receiving module 580 is configured to receive a manner of receiving the two-dimensional verification code from the terminal, the manner including receiving, the two-dimensional verification, code at a specified receiving end and/or locally receiving the two-dimensional verification code in the form of a one-time pop-up window; where the specified receiving end is at least one of a specified email, a specified instant messaging account, and a specified mobile phone number.

The user information is used to uniquely identify a user; the generated properties include at least one of usage count, usage duration, usage scenario range, and usage permission within the usage scenario range of the two-dimensional verification code; the unique identifier is used to identify the current two-dimensional verification code among all two-dimensional verification codes; and the anti-counterfeiting encryption stung is used to authenticate the current two-dimensional verification code.

The two-dimensional code sending module 590 is configured to send the two-dimensional verification code to the specified receiving end and/or the terminal according to the manner.

In conclusion, according to the two-dimensional code generation system provided in this embodiment, a terminal sends a manner of receiving a two-dimensional verification code to a verification server, the verification server sends the two-dimensional verification code to a specified receiving end and/or sends the two-dimensional verification code in the form of a one-time pop-up window to the terminal according to the manner received from the terminal. In this way, an effect of preventing the two-dimensional verification code from being randomly acquired is achieved.

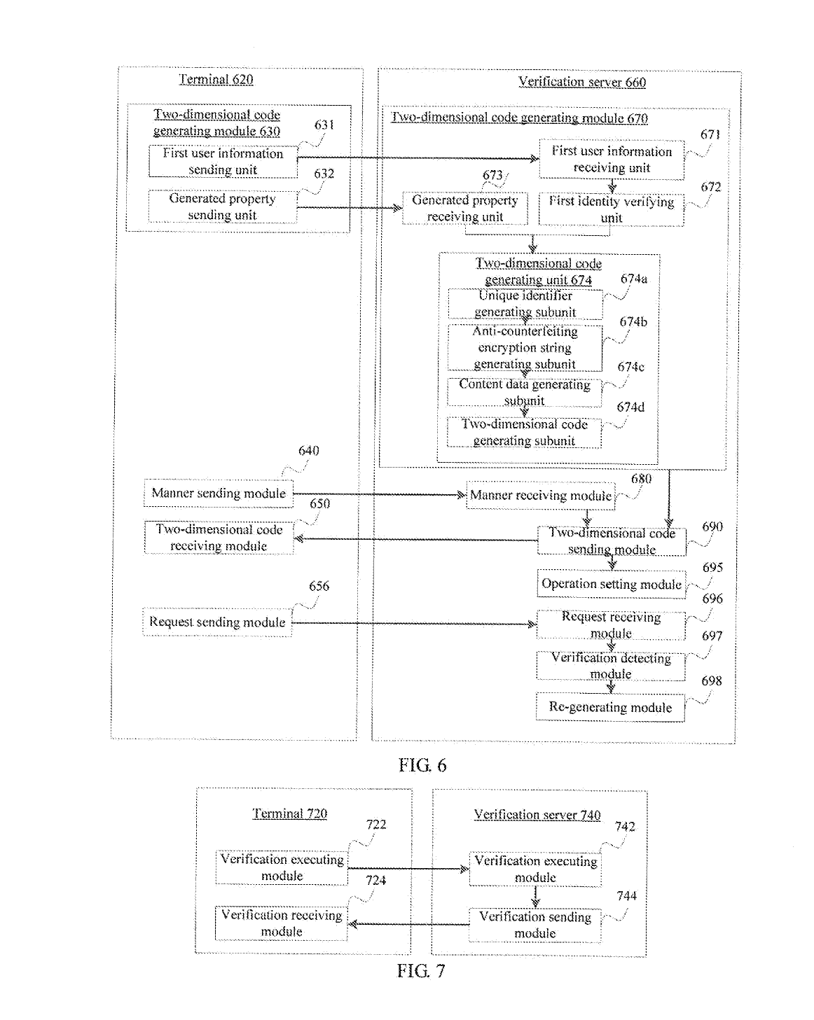

Referring to FIG. 6, a structural block diagram of a two-dimensional code generation system according to another embodiment of the present disclosure is illustrated. Content data in a two-dimensional verification code may include user information, and none or at least one of generated properties, a unique identifier, and an anti-counterfeiting encryption string. In this embodiment, a two-dimensional verification code including the user information, the generated properties, the unique identifier, and the anti-counterfeiting encryption string is used as an example for description. The two-dimensional code generation system includes: a terminal 620 and a verification server 660.

The terminal 620 includes: a two-dimensional code generating module 630, a manner sending module 640, a two-dimensional code receiving module 650, and a request sending module 656.

The two-dimensional code generating module 630 is configured to generate a two-dimensional verification code by interacting with a verification server, content data in the two-dimensional verification code including user information, and none or at least one of generated properties, a unique identifier, and an anti-counterfeiting encryption string.

Specifically, the two-dimensional code generating module 630 includes: a first user information sending unit 631 and a generated property sending unit 632.

The first user information sending unit 631 is configured to send user information to the verification server.

The generated property sending unit 632 is configured to send generated properties of the two-dimensional verification code to the verification server.

The manner sending module 640 is configured to send a manner of receiving the two-dimensional verification code to the verification server, the manner including receiving the two-dimensional verification code at a specified receiving end and/or locally receiving the two-dimensional verification code in the form of a one-time pop-up window; where the specified receiving end is at least one of a specified email, a specified instant messaging account, and a specified mobile phone number;

The user information is used to uniquely identify a user; the generated properties include at least one of usage count, usage duration, usage scenario range, and usage permission within the usage scenario range of the two-dimensional verification code; the unique identifier is used to identify the current two-dimensional verification code among all two-dimensional verification codes; and the anti-counterfeiting encryption string is used to authenticate the current two-dimensional verification code.

The two-dimensional code receiving module 650 is configured to receive and store the two-dimensional verification code sent by the verification server.

If the verification server sends the two-dimensional verification code to the specified receiving end, the user opens the specified receiving end to receive the two-dimensional verification code. For example, if the specified receiving end is an email, the user may open the email box on the terminal or on another terminal, and receive and store the two-dimensional verification code; if the specified receiving end is an instant messaging account, the user may open the instant messaging account on the terminal or on another terminal, and receive and store the two-dimensional verification code; if the sped fled receiving end is a mobile phone number, the user may receive and store the two-dimensional verification code on the mobile phone in the form of a multimedia message; and in addition, the user may store the two-dimensional verification code in the form of an electronic picture or a piece of paper with the two-dimensional verification code primed thereon.

If the verification server sends the two-dimensional verification code to the terminal in the form of a one-time pop-up window, and the user receives, on the terminal, the pop-up window displaying the two-dimensional verification code, the user may store the two-dimensional verification code in the form of an electronic picture or a piece of paper with the two-dimensional verification code primed thereon.

The request sending module 656 is configured to send a request for re-generating the two-dimensional verification code to the verification server.

The verification server 660 includes: a two-dimensional code generating module 670, a manner receiving module 680, a two-dimensional code sending module 690, an operation setting module 695, a request receiving module 696, a verification detecting module 697, and a re-generating module 698.

The two-dimensional code generating module 670 is configured to generate a two-dimensional verification code by interacting with a terminal, content data in the two-dimensional verification code including user information, and none or at least one of generated properties, a unique identifier, and an anti-counterfeiting encryption string.

The user information is used to uniquely identify a user, the generated properties include at least one of usage count, usage duration, usage scenario range, and usage permission within the usage scenario range of the two-dimensional verification code; the unique identifier is used to identify the current two-dimensional verification code among all two-dimensional verification codes; and the anti-counterfeiting encryption string is used to authenticate the current two-dimensional verification code.

Specifically, the two-dimensional code generating module 670 includes: a first user information receiving unit 671, a first identity verifying unit 672, a generated property receiving unit 673, and a two-dimensional code generating unit 674.

The first user information receiving unit 671 is configured to receive user information from the terminal.

The first identity verifying unit 672 is configured to verify an identity of the terminal according to the user information received by the first user information receiving unit 671.

The generated property receiving unit 673 is configured to receive the generated properties of the two-dimensional verification code from the terminal.

The two-dimensional code generating unit 674 is configured to generate the two-dimensional verification code.

Specifically, the two-dimensional code generating unit 674 includes: a unique identifier generating subunit 674a, an anti-counterfeiting encryption string generating subunit 674b, a content data generating subunit 674c, and a two-dimensional code generating subunit 674d.

The unique identifier generating subunit 674a is configured to generate a unique identifier of the two-dimensional verification code.

The anti-counterfeiting encryption string generating subunit 674b is configured to generate an anti-counterfeiting encryption string of the two-dimensional verification code.

The content data generating subunit 674c is configured to generate content data according to the user information received by the first user information receiving unit 671, the generated properties of the two-dimensional verification code received by the generated property receiving unit 673, the unique identifier of the two-dimensional verification, code generated by the unique identifier generating subunit 674a, and the anti-counterfeiting encryption string generated by the anti-counterfeiting encryption string generating subunit 674b.

The two-dimensional verification code generation subunit 674d is configured to generate the two-dimensional verification code according to the content data generated by the content data generating subunit. 674c.

The manner sending module 680 is configured to receive a trimmer of receiving the two-dimensional verification code from the terminal, the manner including receiving the two-dimensional verification code at a specified receiving end and/or locally receiving the two-dimensional verification code in the form of a one-time pop-up window; where the specified receiving end is at least one of a specified email, a specified instant messaging account, and a specified mobile phone number.

The two-dimensional code generating module 690 is configured to send the two-dimensional verification code to the specified receiving end and/or send the two-dimensional verification code in the form of a one-time pop-up window.

The specified receiving end is at least one of an email, an instant messaging account, and a mobile phone number.

The operation setting module 695 is configured to: after the two-dimensional code sending module sends the two-dimensional verification code to the terminal, automatically set an operation of re-generating the two-dimensional verification code as a sensitive operation, the sensitive operation being an operation that is executable when first-type verification and second-type verification are both successful.

The first-type verification includes at least one of user information verification, dynamic verification code verification, network shield verification, and token verification.

The second-type verification includes two-dimensional code verification.

The request receiving module 696 is configured to receive a request for re-generating the two-dimensional verification code from a terminal.

The verification detecting module 697 is configured to detect whether the first-type verification and the second-type verification are both successful.

The re-generating module 698 is configured to re-generate a two-dimensional verification code when the verification detecting module detects that the first-type verification and the second-type verification are both successful.

In conclusion, according to the two-dimensional code generation system provided in this embodiment, a terminal sends a manner of receiving a two-dimensional verification code to a verification server, the verification server sends the two-dimensional verification code to a specified receiving end and/or sends the two-dimensional verification code in the form of a one-time pop-up window to the terminal according to the manner received from the terminal. In this way, an effect of preventing the two-dimensional verification code from being randomly acquired is achieved. In addition, after the verification server sends the two-dimensional verification code to the specified receiving end and/or sends the two-dimensional verification code in the form of a one-time pop-up window, an operation of re-generating the two-dimensional verification code is automatically set as a sensitive operation, thereby achieving an effect of preventing the two-dimensional verification code from being randomly generated.

Referring to FIG. 7, a structural block diagram of a co-verification system according to an embodiment of the present disclosure is illustrated. The co-verification system includes: a terminal 720 and a verification server 740.

The terminal 720 includes: a verification executing module 722 and a verification receiving module 724.

The verification executing module 722 is configured to perform first-type verification and second-type verification with a verification server, the first-type verification including at least one of user information verification, dynamic verification code verification, network shield verification, and token verification, and the second-type verification including two-dimensional verification,

The verification receiving module 724 is configured to receive feedback information from the verification server, the feedback information being information sent by the verification server when the first-type verification and the second-type verification are both successful.

The verification server 740 includes: a verification executing module 742 and a verification sending module 744.

The verification executing module 742 is configured to perform first-type verification and second-type verification with a terminal, the first-type verification including at least one of user information verification, dynamic verification code verification, network shield verification, and token verification, and the second-type verification including two-dimensional verifications.

The verification sending module 744 is configured to send feedback information to the terminal when the first-type verification and the second-type verification performed by the verification executing module are both successful.

In conclusion, by introducing two-dimensional code verification into the conventional co-verification system, the problem in the conventional co-verification system that a user may encounter great loss once others take advantages of a terminal to complete identity verification with a verification server if the terminal is implanted with Trojan virus or lost is solved, thereby achieving an effect of secure verification.

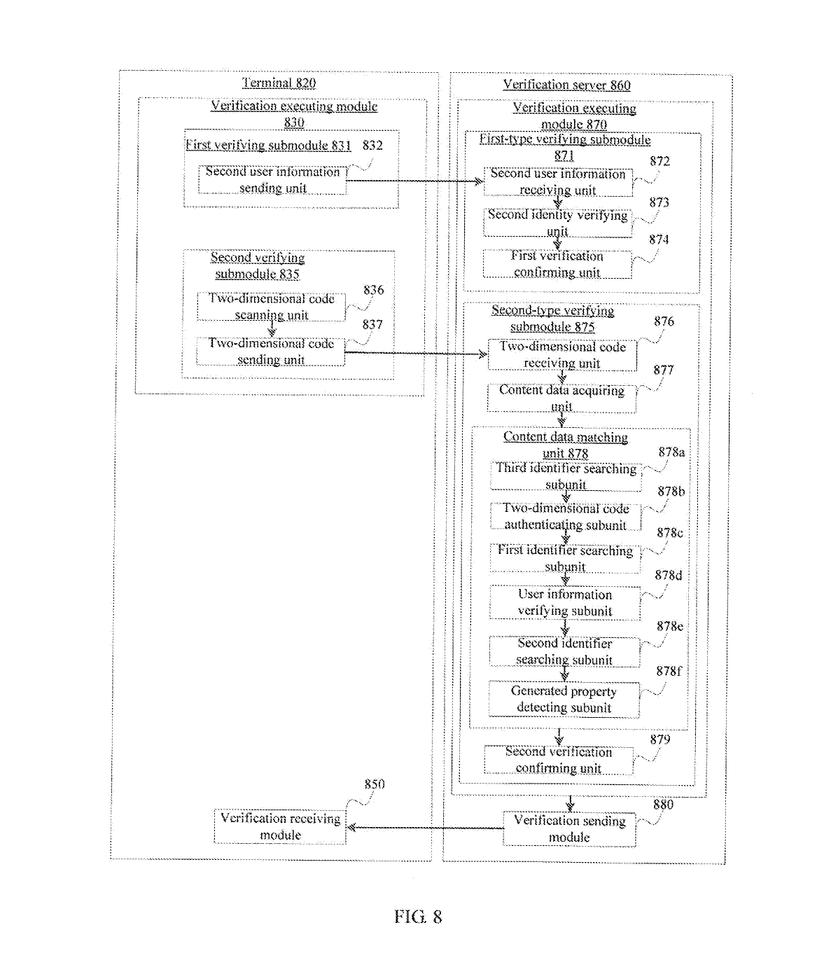

Referring to FIG. 8, a structural block diagram of a co-verification system according to another embodiment of the present disclosure is illustrated. In this embodiment, a case where first-type verification includes only user information verification, and content data in a two-dimensional verification, code involved in second-type verification includes user information, generated properties, a unique identifier, and an anti-counterfeiting encryption string is used as an example for description. For details of embodiments involving other types of verification, reference may be made to the above description, which is readily envisaged by a person skilled in the art and is thus not described herein any further. The co-verification system includes: a terminal 820 and a verification server 860.

The terminal 820 includes: a verification executing module 830 and a verification receiving module 850.

The verification executing module 830 is configured to perform first-type verification and second-type verification with a verification server, the first-type verification including at least one of user information verification, dynamic verification code verification, network shield verification, and token verification, and the second-type verification including two-dimensional verification.

Specifically, the verification executing module 830 includes: a first-type verifying submodule 831 and a second-type verifying submodule 835.

The first-type verifying submodule 831 is configured to perform first-type verification with the verification server.

Specifically, the first-type verifying submodule 831 includes a second user information sending unit 832.

The second user information sending unit 832 is configured to send user information to the verification server when the terminal needs to be verified again.

The second-type verifying submodule 835 is configured to perform second-type verification with the verification server.

Specifically, the second-type verifying submodule 835 includes: a two-dimensional code scanning unit 836 and a two-dimensional code sending unit 837.

The two-dimensional code scanning unit 836 is configured to scan to acquire a two-dimensional verification code.

The two-dimensional code sending unit 837 is configured to send the two-dimensional verification code acquired by the two-dimensional code scanning unit.

The verification receiving module 850 is configured to receive feedback information from the verification server.

The verification server 860 includes: a verification executing module 870 and a verification sending module 880.

The verification executing module 870 is configured to perform first-type verification and second-type verification with a terminal, the first-type verification including at least one of user information verification, dynamic verification code verification, network shield verification, and token verification, and the second-type verification including two-dimensional verifications.

Specifically, the verification executing module 870 includes: a first-type verifying submodule 871 and a second-type verifying submodule 875.

The first-type verifying submodule 871 is configured to perform first-type verification with the terminal.

Specifically, the first-type verifying submodule 871 includes: a second user information receiving unit 872, a second identity verifying unit 873, and a first verification confirming unit 874.

The second user information receiving unit 872 is configured to receive user information sent by the terminal when the terminal needs to be verified again.

The second identity verifying unit 873 is configured to verify an identity of the terminal according to the user information received by the second user information receiving unit 872.

The first verification confirming unit 874 is configured to confirm success of the verification when the second identity verification unit 873 has successfully verifies the identity of the terminal.

The second-type verifying submodule 875 is configured to perform second-type verification with the terminal.

Specifically, the second-type verifying submodule 875 includes: a two-dimensional code receiving unit 876, a content data acquiring unit 877, a content data matching unit 878, and a second verification confirming unit 879,

The two-dimensional code receiving unit 876 is configured to receive a two-dimensional verification code from the terminal.

The content data acquiring unit. 877 is configured to acquire content data in the two-dimensional verification code received by the two-dimensional code receiving unit 876.

The content data matching unit 878 is configured to match the content data acquired by the content data acquiring unit 877 with internally stored content data.

Specifically, the content data matching unit 878 includes: a third identifier searching subunit 878a, a two-dimensional code authenticating subunit 878b, first identifier searching subunit 878c, a user information verifying subunit 878d, a second identifier searching subunit 878e, and a generated property detecting subunit 878f.

The third identifier searching subunit 878a is configured to search, according to the unique identifier in the content data acquired by the content acquiring unit 877, in the internally stored content data for an anti-counterfeiting encryption string corresponding to the current two-dimensional verification code.

The two-dimensional code authenticating subunit 878b is configured to authenticate the current two-dimensional verification code according to the anti-counterfeiting encryption string acquired by the third identifier searching subunit 878a.

The first identifier searching subunit 878c is configured to search, according to the unique identifier in the content data acquired by the content acquiring unit 877, in the internally stored content data for user information corresponding to the current two-dimensional verification code.

The user information verifying subunit 878d is configured to match the user information acquired by the first identifier searching subunit 878c with pre-stored user information.

The second identifier searching subunit 878e is configured to search, according to the unique identifier in the content data acquired by the content acquiring unit 877, in the internally stored content data for generated properties corresponding to the current two-dimensional verification code.

The generated property detecting subunit 878f is configured to detect whether the generated properties in the two-dimensional verification code acquired by the second identifier searching subunit 878e satisfy predetermined conditions.

The predetermined conditions include a current usage count of the two-dimensional verification code being smaller than the usage count specified in the generated properties, current usage time of the two-dimensional verification code falling within the usage duration specified in the generated properties, a current usage scenario range of the two-dimensional verification code being within the usage scenario range specified in the generated properties, and a usage permission within the usage scenario range of the two-dimensional verification code being smaller than or equal to the usage permission within the usage scenario range specified in the generated properties.

The second verification confirming unit 879 is configured to confirm that the second-type verification is successful after the content data matching unit 878 successfully matches the content data in the two-dimensional verification code.

The verification sending module 880 is configured to send feedback information to the terminal when the first-type verification and the second-type verification performed by the verification executing module are both successful.

In conclusion, by introducing two-dimensional code verification into the conventional co-verification system, the problem in the conventional co-verification system that a user may encounter great loss once others take advantages of a terminal to complete identity verification with a verification server if the terminal is implanted with Trojan virus or lost is solved, thereby achieving an effect of secure verification. In this embodiment, during two-dimensional code verification, verification of user information in content data, generated properties, a unique identifier, and an anti-counterfeiting encryption string of the two-dimensional code enables more secure two-dimensional code verification, thereby achieving an effect of more secure verification.

It should be noted that, during co-verification performed by the co-verification system provided in the above embodiments, the system according to the above embodiments is described by only using division of the above functional modules as an example. In practice, the functions may be assigned to different functional modules for implementation as required. To be specific, the internal structure of the system is divided into different functional modules to implement all or part of the above-described functions. In addition, the co-verification system and method provided in the embodiments of the present disclosure pertain to the same inventive concept, where the specific implementation is elaborated in the method embodiments, which is not detailed herein any further.

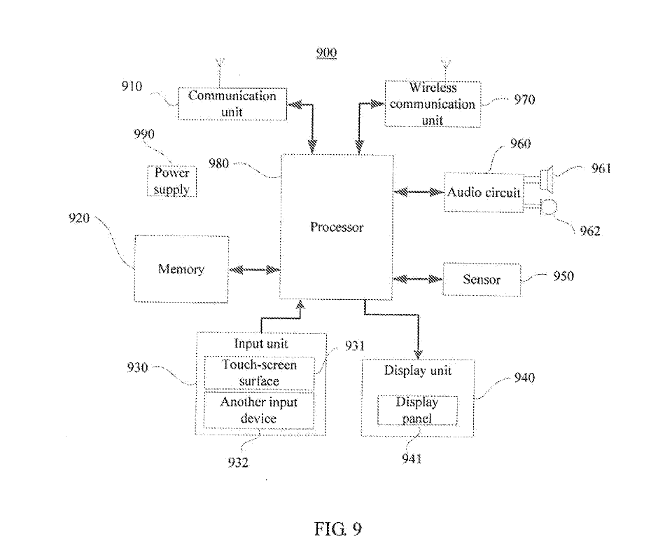

Referring to FIG. 9, a structural block diagram of a terminal according to an embodiment of the present disclosure is illustrated. A terminal 900 may include such components as a communication unit 910, a memory 920 including at least one non-transitory computer-readable storage medium, an input unit 930, a display unit 940, a sensor 950, an audio circuit 960, a wireless communication unit 970, a processor 980 including at least one processing core, and a power supply 990. A person skilled in the art may understand that the structure of the terminal as illustrated in FIG. 9 does not construe a limitation on the terminal. The terminal may include more components over those illustrated in FIG. 9, or combinations of some components, or employ different component deployments.

The communication unit 910 may be configured to receive and send messages, or receive and send signals during a call, and may be such a network communication devices as a radio frequency (RE) circuit, a router, and a modem. Particularly, when the communication unit 910 is an RE circuit, after receiving downlink data from a base station, the communication unit 110 hands the received information over to the at least one processor 980, and additionally sends uplink data to the base station. Typically, the RE circuit serving as the communication unit includes, but not limited to, an antenna, at least one amplifier, a tuner, at least one oscillator, a subscriber identity module (SIM) card, a transceiver, a coupler, a low noise amplifier (LNA), a duplexer, and the like. In addition, the communication unit 910 may also communicate with another network or device using wireless communication. The wireless communication can use any communication standard or protocol, including but not limited to: global system for mobile communications (GSM), general packet radio service (GPRS), code division multiple access (CDMA), wideband code division multiple access (WCDMA), long term evolution (LTE), email, short messaging service (SMS), and the like. The memory 920 may be configured to a software program and a module; the processor 980 executes various function applications and data processing by running the software program and module stored m the memory 920. The memory 920 mainly includes a program storage partition and a data storage partition. The program storage partition may store an operating system, at least one application for implementing a specific function (for example, audio playing function, image playing function, and the like). The data storage partition may store data created according to use of the terminal 900 (for example, audio data, address book, and the like). In addition, the memory 920 may include a high speed random access memory, or include a non-volatile memory, for example, at least one disk storage device, a flash memory device, or another non-volatile solid storage device. Correspondingly, the memory 920 may further include a memory controller, for providing access to the memory 920 for the processor 980 and an input unit 930.

The inputting unit 930 may be configured to receive input numbers and characters, and generate signal input of a keyboard, a mouse, an operation rod, an optical or track ball related to user settings and function control. Preferably, the inputting unit 930 may include a touch-sensitive surface 931 and another input device 932. The touch-screen surface 931 is also referred to as a touch screen or a touch control plate, is capable of collecting a touch operation performed by a user thereon or therearound (for example, an operation performed by the user using fingers, touch pens, or other suitable objects or accessories on or around the touch-sensitive surface 931), and drive a corresponding connection apparatus according to a preset program. Optionally, the touch-sensitive surface 931 may include a touch detecting apparatus and a touch controller. The touch detecting apparatus detects a touch azimuth of the user, detects a signal generated by the touch operation, and transmits the signal to the touch controller. The touch controller receives touch information from the touch detecting apparatus, transforms the information into a touch point coordinate, sends the coordinate to the processor 980, and receives a command issued by the processor 980 and run the command. In addition, resistive, capacitive, infrared, and surface acoustic wave technologies ma be used to implement the touch-sensitive surface 931. In addition to the touch-sensitive surface 931, the input unit 930 may further include another input device 932. Preferably, the another input device 932 includes but not limited to one or a plurality of a physical keyboard, a function key (for example, a volume control key, and a switch key), a track hall, a mouse, an operation rod, and the like.

The display unit 940 may be configured to display information input by the user or information provided to the user, and various graphical user interfaces of the terminal 900. These graphical user interfaces may be formed by graphics, texts, icons, and videos or any combination thereof. The display unit 940 may include a display panel 941. Optionally, the display panel 941 may be configured by using a liquid crystal display (LCD), an organic light-emitting diode (OLED) or the like. Further, the touch-sensitive surface 931 may cover the display panel 941. When detecting a touch operation thereon on therearound, the touch-sensitive surface 931 transfers the operation to the processor 980 to determine the type of the touch event. Subsequently, the processor 980 provides corresponding visual output on the display panel 941 according to the type of the touch event. In FIG. 9, although the touch-screen surface 931 and the display panel 941 are two independent components to implement input and output functions. However, in some embodiments, the touch-sensitive surface 931 may be integrated with the display panel 941 to implement the input and output functions.

The terminal 900 may further include at least one sensor 950, for example, a light sensor, a motion sensor, or another type of sensor. Specifically, the optical sensor may include an ambient light sensor and a proximity sensor, where the ambient light sensor is capable of adjusting luminance of the display panel 941 according to the intensity of the ambient light, and the proximity sensor is capable of shutting the display pane and/or backlight when the terminal 900 is moved to the ears. As a type of motion sensor, a gravity sensor is capable of detecting the acceleration of each direction (typically three axes), and when in the static state, is capable of the magnitude and direction of the gravity. The gravity sensor may be applicable to an application for recognizing mobile phone gestures (for example, switching between horizontal and vertical screens, and gesture calibration in games and magnetometers), and provides the vibration-based recognition function (for example, pedometers and knocks). The terminal 900 may further include a gyroscope, a barometer, a hygrometer, a thermometer, and other sensors such as an infrared sensor, which are not described herein any further.

The audio circuit 960, a loudspeaker 961, and a microphone 962 are capable of providing audio interfaces between the user and the terminal 900. The audio circuit 960 is capable of transmitting an electrical signal acquired by converting the received audio data to the loudspeaker 961. The loudspeaker 961 converts the electrical signal into a voice signal for output. In another aspect, the microphone 962 converts the collected voice signals into the electrical signals, and the audio circuit 960 converts the electrical signals into audio data, and then outputs the audio data to the processor 980 for processing. The processed audio data is transmitted by the communication unit 910 to another terminal; or the processed audio data is output to the memory for further processing. The audio circuit 960 may further include an earphone plug for providing communication of an external earphone with the terminal 900.

To implement wireless communication, the terminal may be configured with a wireless communication unit 970, where the wireless communication unit 970 may be a Wi-Fi module. WiFi is a short-distance wireless transmission technology. The terminal device 900 facilitates user's receiving and sending emails, browsing webpages, and accessing streaming media, by using the wireless communication unit 970. The wireless communication unit provides wireless broadband Internet access services for users. Although FIG. 9 illustrates the wireless communication unit 970, it may be understood that the wireless communication unit is not an indispensable component for the terminal device, and may not be configured as required within the essence and scope of the present disclosure.

The processor 980 is a control center of the terminal 900, and connects all parts of a mobile phone by using various interfaces and lines, and implements various functions and data processing of the terminal 900 to globally monitor the mobile phone, by running or performing software programs and/or modules stored in the memory 920 and calling data stored in the memory 920. Optionally, the processor 980 may include at least one processor core. Preferably, the processor 980 may integrate an application processor and a model processor, where the application processor is mainly responsible for processing the operating system, user interface, and application program; and the modem processor is mainly responsible for performing wireless communication. It may be understood that the modem processor may also not be integrated in the processor 980.

The terminal 900 further includes a power supply 990 (for example, a battery) supplying power for all the components. Preferably, the power supply may be logically connected to the processor 980 by using a power management system, such that such functions as charging management, discharging management, and power consumption management are implemented by using the power supply management system. The power supply 990 may further include at least one DC or AC power supply, a recyclable charging system, a power fault detection circuit, a power converter or inverter, a power state indicator, and the like.

Although no detail illustration is given, the terminal 900 may further include a camera, a Bluetooth module, and the like, which is not described herein any further.

In this embodiment, the terminal further includes at least one program. The at least one program is stored on the memory and configured to be executed by at least one processor. The at least one program includes instructions for performing the two-dimensional code generation method and/or the co-verification method according to the embodiment of the present disclosure.

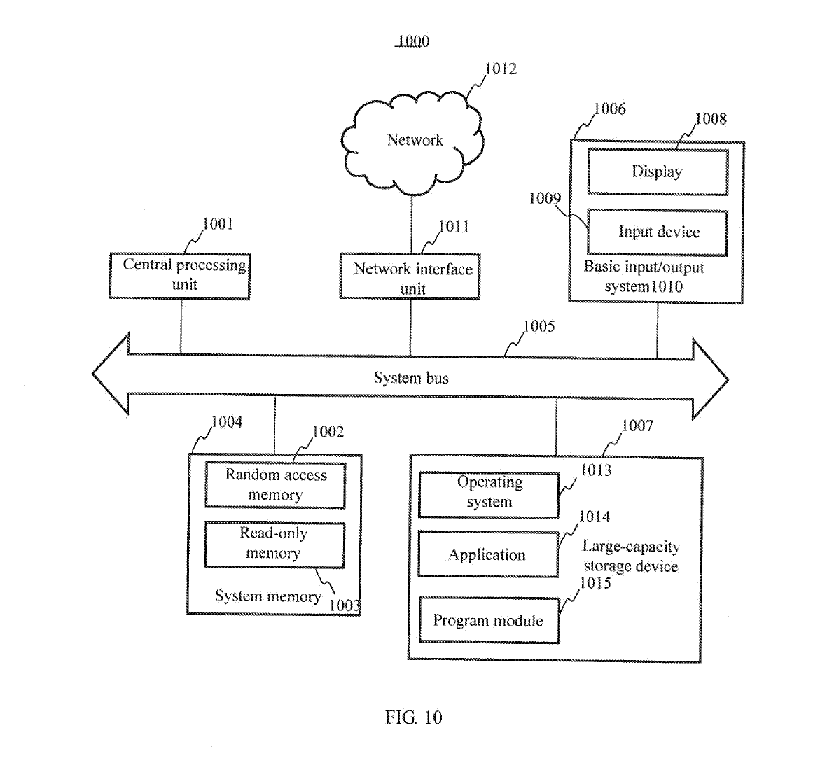

Referring to FIG. 10, a schematic structural diagram of a verification server according to an embodiment of the present disclosure is illustrated. A verification server 1000 includes a central processing unit (CPU) 1001, a system memory 1004 including a random access memory (RAM) 1002 and a read-only memory (ROM) 1003, and a system bus 1005 communicatively connecting the system memory 1004 and the CPU 1001. The verification server 1000 further includes a basic input/output system (BIOS) 1006 for facilitating information transmission between various components within a computer, and a large-capacity storage device 1007 for storing an operating system 1013, an application 1014, and a program module 1015.

The BIOS 1006 includes a display 1008 for displaying information, and an input device 1009 such as a mouse and a keyboard, for information input by a user. The display 1008 and the input device 10098 are both communicatively connected to the CPU 1001 by using an input/output (I/O) controller 1010 communicatively connected to the system bus 1005. The BIOS 1006 may further include the I/O controller 1010 to receive and process inputs from such devices as a keyboard, a mouse, or an electronic stylus touch pen. Analogously, the I/O controller 1010 further provides outputs to a display screen, a printer, or another type of output device.

The large-capacity storage device 1007 is communicatively connected to the CPU 1001 by using a large-capacity storage controller (not shown in FIG. 10) communicatively connected to the system bus 1005. The large-capacity storage device 1007 and the non-transitory computer-readable storage medium associated therewith provide non-volatile storage for the verification server 1000. To be specific, the large-screen storage device 1007 may include a non-transitory compute-readable storage medium (not shown in FIG. 10), for example, a hard disk or a CD-ROM driver.

Without loss of generality, the non-transitory computer-readable storage medium may include a computer storage medium and a communication media. The computer storage medium includes volatile and non-volatile, movable and unmovable media that are implemented using any method and technology for storing information such as computer-readable instructions, data structures, program modules, or other data. The non-transitory computer-readable medium includes a RAM, a ROM, an EPROM, an EEPROM, a flash memory, or another such solid storage technology-based storage device; a CD-ROM, a DVD, or another such optical storage device; and a data cartridge, a magnetic card, a magnetic tape, or another such magnetic storage device. Nevertheless, a person skilled in the art may know that the non-transitory computer-readable storage medium is not limited to what are listed above. The system memory 1004 and the large-capacity storage device 1007 may be uniformly referred to as a memory.

According to the embodiments of the present disclosure, the verification server 1000 may be further communicatively connected to a remote computer on the network by using a network such as the Internet, and may run on the computer. To be specific, the verification server 1000 may be communicatively connected to a network 1012 by using a network interface unit 1011 communicatively connected to the system bus 1005, or the verification server 1005 may be communicatively connected to another type of network or a remote computer system (not shown in FIG. 10) by using the network interface unit 1011.

The memory further includes at least one program. The at least one program is stored on the memory, and includes instructions for performing the two-dimensional code generation method and/or the co-verification method according to the embodiment of the present disclosure.

Obviously the terminal provided in the embodiment illustrated in FIG. 9 and the verification server provided in the embodiment illustrated in FIG. 10 may further form the two-dimensional code verification system or the co-verification system according to the present disclosure.

The sequence numbers of the preceding embodiments of the present disclosure are only for ease of description, but do not denote the preference of the embodiments.

A person skilled in the art should understand that all or part of steps of the preceding methods may be implemented by hardware or hardware following instructions of programs. The programs may be stored in a non-transitory computer-readable storage medium and may be executed by at least one processor. The storage medium may be a read-only memory, a magnetic disk, or a compact disc-read only memory.

Described above are merely preferred embodiments of the present disclosure, but are not intended to limit the present disclosure. Any modification, equivalent replacement, or improvement made without departing from the spirit and principle of the present disclosure should fall within the protection scope of the present disclosure.

1-2. (canceled)

3. A co-verification method, comprising:
performing first-type verification and second-type verification with a terminal, the first-type verification comprising at least one of user information verification, dynamic verification code verification, network shield verification, and token verification, and the second-type verification comprising two-dimensional code verification; and
sending feedback information to the terminal when the first-type verification and the second-type verification are both successful.

4. The method according to claim 3, wherein the performing second-type verification with a terminal comprises:
receiving a two-dimensional verification code from the terminal;
matching content data in the received two-dimensional verification code with internally stored content data;
confirming that the second-type verification is successful when the matching is successful.

5. The method according to claim 4, wherein the content data in the two-dimensional verification code comprises user information, the user information being used to identify a user; and
the matching content data in the received two-dimensional verification code with internally stored content data comprise:
matching the user information and user information in the internally stored content data.

6. The method according to claim 5, wherein the content data in the two-dimensional verification code further comprises generated properties, the generated properties comprising at least one of usage count, usage duration, usage scenario range, and usage permission within the usage scenario range; and
after the matching the user information and user information in the internally stored content data, the method further comprises:
detecting whether the generated properties in the two-dimensional verification code satisfy predetermined conditions;
wherein the predetermined conditions comprise: a current usage count of the two-dimensional verification code being smaller than the usage count specified in the generated properties, current usage time of the two-dimensional verification code falling within the usage duration specified in the generated properties, a current usage scenario range of the two-dimensional verification code being within the usage scenario range specified in the generated properties, and a usage permission within the usage scenario range of the two-dimensional verification code being smaller than or equal to the usage permission within the usage scenario range specified in the generated properties.

7-8. (canceled)

9. A two-dimensional code generation method, comprising:
generating a two-dimensional verification code by interacting with a terminal, content data in the two-dimensional verification code comprising user information, and none or at least one of generated properties, a unique identifier, and an anti-counterfeiting encryption string; and
receiving a manner of receiving the two-dimensional verification code from the terminal, the manner comprising receiving the two-dimensional verification code at a specified receiving end and/or locally receiving the two-dimensional verification code in the form of a one-time pop-up window; wherein the specified receiving end is at least one of a specified email, a specified instant messaging account, and a specified mobile phone number;
sending the two-dimensional verification code to the specified receiving end and/or the terminal according to the manner;
wherein the user information is used to uniquely identify a user; the generated properties comprise at least one of usage count, usage duration, usage scenario range, and usage permission within the usage scenario range, of the two-dimensional verification code; the unique identifier is used to identify the two-dimensional verification code among all two-dimensional verification codes; and the anti-counterfeiting encryption string is used to authenticate the two-dimensional verification code.

10. The method according to claim 9, wherein after the sending the two-dimensional verification code to the specified receiving end and/or the terminal according to the manner, the method further comprises:
automatically setting an operation of re-generating the two-dimensional verification code as a sensitive operation, the sensitive operation being an operation that is executable only when first-type verification and second-type verification are both successful;
wherein the first-type verification comprises at least one of user information verification, dynamic verification code verification, network shield verification, and token verification; and
the second-type verification comprises two-dimensional code verification.

11. The method according to claim 10, wherein after the automatically setting an operation of re-generating the two-dimensional verification code as a sensitive operation, the method further comprises:
receiving a request for re-generating the two-dimensional verification code from a terminal;
detecting whether the first-type verification and the second-type verification are both successful; and
if it is detected that the first-type verification and the second-type verification are both successful, re-generating the two-dimensional verification code.

12-22. (canceled)

23. A co-verification system, comprising a terminal and a verification server, the terminal being communicatively connected to the verification server over a wired network or a wireless network; wherein
the terminal is configured to perform first-type verification and second-type verification with a verification server, the first-type verification comprising at least one of user information verification, dynamic verification code verification, network shield verification, and token verification, and the second-type verification comprising two-dimensional code verification;
the verification server is configured to send feedback information to the terminal when the first-type verification and the second-type verification are both successful; and
the terminal is configured to receive feedback information from the verification server, the feedback information being information sent by the verification server when the first-type verification and the second-type verification are both successful.

24. A two-dimensional code generation system, comprising a terminal and a verification server, the terminal being communicatively connected to the verification server over a wired network or a wireless network; wherein
the terminal is configured to generate a two-dimensional verification code by interacting with a verification server, content data in the two-dimensional verification code comprising user information, and none or at least one of generated properties, a unique identifier, and an anti-counterfeiting encryption string;
the terminal is configured to send a manner of receiving the two-dimensional verification code to the verification server, the manner comprising receiving the two-dimensional verification code at a specified receiving end and/or locally receiving the two-dimensional verification code in the form of a one-time pop-up window; wherein the specified receiving end is at least one of a specified email, a specified instant messaging account, and a specified mobile phone number;
the verification server is configured to receive a manner of receiving the two-dimensional verification code from the terminal, the manner including receiving the two-dimensional verification code at a specified receiving end and/or locally receiving the two-dimensional verification code in the form of a one-time pop-up window; where the specified receiving end is at least one of a specified email, a specified instant messaging account, and a specified mobile phone number; and
the verifications server is further configured to send the two-dimensional verification code to the specified receiving end and/or the terminal according to the manner;
wherein the user information is used to uniquely identify a user; the generated properties comprise at least one of usage count, usage duration, usage scenario range, and usage permission within the usage scenario range, of the two-dimensional verification code; the unique identifier is used to identify a two-dimensional verification code among all two-dimensional verification codes; and the anti-counterfeiting encryption string is used to authenticate the two-dimensional verification code.

25. The method according to claim 6, wherein the content data in the two-dimensional verification code further comprises a unique identifier, the unique identifier being used to identify the current two-dimensional verification code among all two-dimensional verification codes; and
prior to the matching the user information and user information in the internally stored content data, the method further comprises:
searching, according to the unique identifier, in the internally stored content data for user information corresponding to the current two-dimensional verification code;
searching, according to the unique identifier, in the internally stored content data for generated properties corresponding to the current two-dimensional verification code.

26. The method according to claim 25, wherein the content data in the two-dimensional verification code further comprises an anti-counterfeiting encryption string, the anti-counterfeiting encryption string being used to authenticate the current two-dimensional verification code; and
prior to the searching, according to the unique identifier, in the internally stored content data for user information corresponding to the current two-dimensional verification code, the method further comprises:
searching, according to the unique identifier, in the internally stored content data for an anti-counterfeiting encryption string corresponding to the current two-dimensional verification code;
authenticating the current two-dimensional verification code according to the anti-counterfeiting encryption string; and
if the current two-dimensional verification code is true, searching, according to the unique identifier, in the internally stored content data for the user information corresponding to the current two-dimensional verification code.

27. A verification server, comprising:
at least one processor; and
a memory;
wherein the memory stores at least one program, wherein the at least one program is configured to be executed by the at least one processor, and the at least one program comprises instructions for performing the following operations:
performing first-type verification and second-type verification with a terminal, the first-type verification comprising at least one of user information verification, dynamic code verification, network shield verification, and token verification, and the second-type verification comprising two-dimensional code verification; and
sending feedback information to the terminal when the first-type verification and the second-type verification are both successful.

28. The verification server according to claim 27, wherein the at least one program further comprises instructions for performing the following operations:
receiving a two-dimensional verification code from the terminal;
matching content data in the received two-dimensional verification code with internally stored content data;
confirming that the second-type verification is successful when the matching is successful.

29. The verification server according to claim 28, wherein the content data in the two-dimensional verification code comprises user information, the user information being used to identify a user; and
the at least one program comprises an instruction for performing the following operation:
matching the user information and user information in the internally stored content data.

30. The verification server according to claim 28, wherein the content data in the two-dimensional verification code further comprises generated properties, the generated properties comprising at least one of usage count, usage duration, usage scenario range, and usage permission within the usage scenario range; and
the at least one program comprises an instruction for performing the following operation:
detecting whether the generated properties in the two-dimensional verification code satisfy predetermined conditions;
wherein the predetermined conditions comprise: a current usage count of the two-dimensional verification code being smaller than the usage count specified in the generated properties, current usage time of the two-dimensional verification code falling within the usage duration specified in the generated properties, a current usage scenario range of the two-dimensional verification code being within the usage scenario range specified in the generated properties, and a usage permission within the usage scenario range of the two-dimensional verification code being smaller than or equal to the usage permission within the usage scenario range specified in the generated properties.

31. The verification server according to claim 30, wherein the content data in the two-dimensional verification code further comprises a unique identifier, the unique identifier being used to identify a current two-dimensional verification code among all two-dimensional verification codes; and
the at least one program comprises instructions for performing the following operation:
searching, according to the unique identifier, in the internally stored content data for user information corresponding to the current two-dimensional verification code;
searching, according to the unique identifier, in the internally stored content data for generated properties corresponding to the current two-dimensional verification code.

32. The verification server according to claim 31, wherein the content data in the two-dimensional verification code further comprises an anti-counterfeiting encryption string, the anti-counterfeiting encryption string being used to authenticate the current two-dimensional verification code; and
the at least one program comprises instructions for performing the following operations:
searching, according to the unique identifier, in the internally stored content data for an anti-counterfeiting encryption string corresponding to the current two-dimensional verification code;
authenticating the current two-dimensional verification code according to the anti-counterfeiting encryption string; and
if the current two-dimensional verification code is true, searching, according to the unique identifier, in the internally stored content data for the user information corresponding to the current two-dimensional verification code.

33. A verification server, comprising:
at least one processor; and
a memory;
wherein the memory stores at least one program, wherein the at least one program is configured to be executed by the at least one processor, and the at least one program comprises instructions for executing the following operations:
generating a two-dimensional verification code by interacting with a terminal, content data in the two-dimensional verification code comprising user information, and none or at least one of generated properties, a unique identifier, and an anti-counterfeiting encryption string; and
receiving a manner of receiving the two-dimensional verification code from the terminal, the manner comprising receiving the two-dimensional verification code at a specified receiving end and/or locally receiving the two-dimensional verification code in the form of a one-time pop-up window; wherein the specified receiving end is at least one of a specified email, a specified instant messaging account, and a specified mobile phone number;
sending the two-dimensional verification code to the specified receiving end and/or the terminal according to the manner;
wherein the user information is used to uniquely identify a user; the generated properties comprise at least one of usage count, usage duration, usage scenario range, and usage permission within the usage scenario range, of the two-dimensional verification code; the unique identifier is used to identify a current two-dimensional verification code among all two-dimensional verification codes; and the anti-counterfeiting encryption string is used to authenticate the current two-dimensional verification code.

34. The verification server according to claim 33, wherein the at least one program further comprises instructions for performing the following operations:
automatically setting an operation of re-generating the two-dimensional verification code as a sensitive operation, the sensitive operation being an operation that is executable only when first-type verification and second-type verification are both successful;
wherein the first-type verification comprises at least one of user information verification, dynamic code verification, network shield verification, and token verification; and
the second-type verification comprises two-dimensional code verification.

35. The verification server according to claim 34, wherein the at least one program further comprises instructions for performing the following operations:
receiving a request for re-generating the two-dimensional verification code from a terminal;
detecting whether the first-type verification and the second-type verification are both successful; and
if it is detected that the first-type verification and the second-type verification are both successful, re-generating the two-dimensional verification code.
